(19) United States
(12) Patent Application Publication
(10) Pub. No.: US 2006/0175975 A1
(43) Pub. Date: Aug. 10, 2006

(54) Fluorescent lamp with auxiliary discharge and method for manufacturing the same

(75) Inventors: Marco Haverlag, Eindhoven (NL); Wilhelmus Marie Hellebrekers, Eindhoven (NL); Rolf Erwin De Man, Eindhoven (NL); Lambert Christiaan Ida Kaldenhoven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/565,812

(22) PCT Filed: Jul. 16, 2004
(86) PCT No.: PCT/IB04/51239

§ 371 Date: Jan. 24, 2006

(30) Foreign Application Priority Data
Jul. 28, 2003 (EP) 03102315.3
Apr. 21, 2004 (EP) 04101646.0

(51) Int. Cl. H01K 1/62; H01J 17/34

(52) U.S. Cl. 315/32; 315/358

(57) ABSTRACT

Fluorescent lamp comprising a glass discharge vessel (2) in which an ionizable and vaporizable filling is present, which discharge vessel is on two sides provided with a tubular end portion including a glass stem, wherein an exhaust tube (6) extends axially outwardly from said stem for supplying and/or discharging gases during production of the lamp, wherein a main electrode (8) extends axially inwardly through the stem for generating and maintaining a discharge in the discharge vessel, and wherein the lamp comprises means including an auxiliary electrode (15) for controlling the pressure of said filling in the vapor phase, despite changes in temperature thereof, with the special feature that said auxiliary electrode is located on at least one end portion for generating and maintaining an auxiliary discharge between the main electrode and the auxiliary electrode.

The invention relates to a fluorescent lamp comprising a glass discharge vessel in which an ionizable and vaporizable filling is present, which discharge vessel is on two sides provided with a tubular end portion including a glass stem, wherein an exhaust tube extends axially outwardly from said stem for supplying and/or discharging gases during production of the lamp, wherein a main electrode extends axially inwardly through the stem for generating and maintaining a discharge in the discharge vessel, and wherein the lamp comprises means including an auxiliary electrode for controlling the pressure of said filling in the vapor phase, despite changes in temperature thereof. An example of such a fluorescent lamp is the neon tube, mark Philips™, with type number F32T8 (also ALTO™T8), a low-pressure mercury vapor discharge lamp, which is commercially available. The inwardly disposed end of the electrode of said fluorescent lamp is furthermore radially surrounded by a shield for intercepting material being discharged by the electrode, which shield is mounted on an elongated support which extends inwardly from the stem.

In mercury vapor discharge lamps, mercury is the primary component for the (efficient) generation of ultraviolet (UV) light. Present on the inside wall of the discharge vessel is a luminescent film comprising a luminescent material (for example a fluorescent powder) for the purpose of converting UV light to light having other wavelengths, for example UV-A and UV-B for tanning purposes (sun bed lamps), or to visible radiation for general lighting purposes. The discharge vessel for fluorescent lamps usually has a circular cross-section, and it comprises both elongated versions (neon tubes) and compact versions (low-energy lamps). With the neon tube, the aforesaid tubular end portions are in line, forming a long, straight tube; with a low-energy lamp they are interconnected by means of a bent tubular portion or a so-called bridge.

During production, a vacuum is generated in the fluorescent lamp by means of the glass exhaust tubes that are disposed on either end of the lamp. Following that, the desired gas mixture is introduced into the lamp through the same exhaust tubes, after which the exhaust tube ends are squeezed, shut and sealed off.

In use, a voltage is maintained between the electrodes that are likewise disposed at either end of the lamp, as a result of which a continuous discharge takes place and the mercury vapor emits the aforesaid UV light. The ends of the electrodes may be surrounded in radial direction by a shield, because the electrodes regularly discharge small particles in use, which particles would land on the inside of the discharge vessel. This is undesirable, since it leads to a local reduction of the light output, causing the lamp to exhibit an irregular light output, and consequently the particles are intercepted by the shield. The shield that may be present is mounted in the glass stem by means of a wire-like support.

A fluorescent lamp according to the preamble of claim 1 is known from U.S. Pat. publication No. 3,246,189 (Sylvania). It is well known that the light output of fluorescent lamps is dependent on ambient temperature. This dependence arises from the fact that mercury vapor pressure inside the lamp depends on the temperature of the coolest part of the lamp bulb, which in turn depends on the temperature of the air in which the lamp is operating. The light output depends on mercury vapor pressure in two ways. First, the efficiency of conversion of electrical energy into UV energy is a maximum at a certain mercury vapor pressure. Second, the power consumed by the lamp on a ballast circuit decreases with increasing mercury vapor pressure. Operation of fluorescent lamps in ambient temperatures differing considerably from the optimum values results both in lower efficiency and lower light output In order to control the mercury vapor pressure, despite increases in temperature of the vapor, the above US patent publication proposes the use of a wall member forming a funnel in the discharge vessel in such a way that the main electrode is enclosed in a separate end chamber in the discharge vessel. With the help of a non-emissive auxiliary electrode acting as an anode and collecting electron discharge from another main electrode at the other end portion of the lamp, an increase of mercury vapor in the end chamber is realized accompanied by a decrease of mercury vapor pressure in a middle part of the discharge vessel, due to electrophoretic pumping of mercury into the end chamber.

A disadvantage of the lamp as described in the above U.S. Pat. publication No. 3,246,189 (Sylvania) is that said pumping in practice appears to be less reliable and effective.

It is an object of the invention to obviate this disadvantage and in order to accomplish that objective a fluorescent lamp of the type mentioned in the preamble according to the invention is characterized in that said auxiliary electrode is located on at least one end portion for generating and maintaining an auxiliary discharge between the main electrode and the auxiliary electrode. Preferably, this emissive auxiliary electrode is located near an end of the exhaust tube facing away from the discharge vessel for generating and maintaining said auxiliary discharge through the exhaust tube acting as a discharge path between the main electrode and the exhaust electrode.

The auxiliary discharge can also be used in combination with dimming circuitry. In that case preferably the lamp is first dimmed, for instance from 100% to 50% of the luminance by decreasing the lamp current, and for further dimming subsequently the mercury pressure is decreased by adapting the current between the main electrode and the auxiliary electrode. According to the prior art it was necessary to provide additional heating of the electrodes to achieve deep dimming (<10%) in an effective manner and avoid a shorter lifetime of the lamp. Special circuitry was provided which allows for an extra current through the electrodes to keep them hot. This however adds to the costs of the circuitry and also requires good standardization in order to avoid a decrease of lifetime of the lamp. Apart from the fact that decreasing the mercury pressure is an effective way for deep dimming the lamp, an additional advantage is that at low values of mercury pressure the discharge emits more radiation from rare-gas lines, whereby the lamp color is shifted towards red at low light levels. In contrast thereto the lamp color in prior art low current fluorescent lamps typically shifts to blue.

In a preferred embodiment of a fluorescent lamp in accordance with the invention the auxiliary electrode being hot or cold is fed by a DC current Therefore, the above electrophoretic pumping of mercury is independent of the alternating current of the discharge between the main electrodes at both end portions of the discharge vessel. The DC current is particularly an average DC current.

In another preferred embodiment of a fluorescent lamp according to the invention the DC current can be varied in order to regulate the pressure of said filling in the vapor phase. Particularly, the DC current can be varied dependent on a temperature on the cathode-side of the auxiliary electrode as measured by means of a thermo-couple, detected change in light output, color change or burner voltage. The DC current is variable compared with a defined vapor pressure, being controllable by pure mercury or an amalgam.

In another preferred embodiment of the fluorescence lamp in accordance with the invention the auxiliary electrode is connected to a passive transformer circuit comprising a coil which is electro-magnetically coupled to coils which are connected to the pole wires of the main electrode. This passive transformer circuit preferably further comprises a diode for generating a DC current through the auxiliary electrode. Thereby additional external wiring and an additional power supply can be avoided.

The invention also refers to a method for manufacturing a fluorescent lamp, wherein a glass discharge vessel is on two sides provided with a tubular end portion including a glass stem, wherein a main electrode is fitted to extend axially inwardly through the stem for generating and maintaining a discharge in the discharge vessel, wherein an exhaust tube is fitted to extend axially outwardly from said stem, through which exhaust tube the discharge vessel is filled with an ionizable and vaporizable filling, and wherein the lamp is provided with means including an auxiliary electrode for controlling the pressure of said filling in the vapor phase, despite changes in temperature thereof, characterized in that said auxiliary electrode is fitted on at least one end portion for generating and maintaining an auxiliary discharge between the main electrode and the auxiliary electrode.

The invention will now be explained in more detail by means of exemplary embodiments as shown in the figures, wherein:

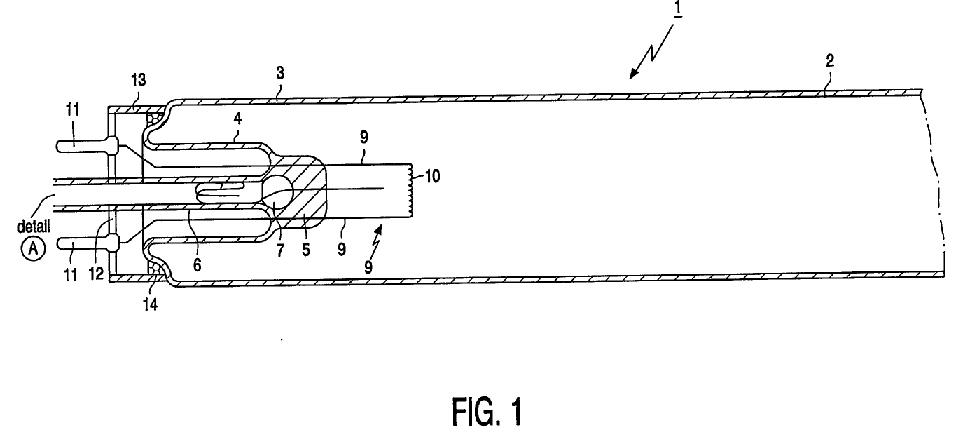

FIG. 1 is a partial cross-sectional view of an embodiment of a fluorescent lamp of the invention,

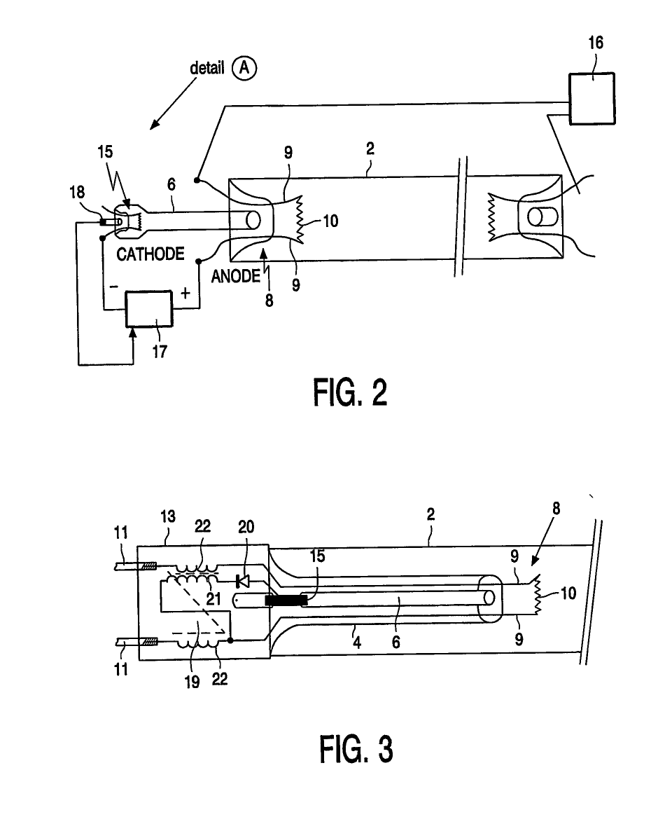

FIG. 2 is a perspective view of a detail of the fluorescent lamp of FIG. 1, and

FIG. 3 shows another embodiment of a fluorescent lamp of the invention.

According to FIG. 1, a fluorescent lamp 1 comprises a glass discharge vessel in the form of a tube 2. The figure only shows the end portion 3 of lamp 1, in actual fact the lamp comprises two opposing, identical end portions 3, which each close one side of a long glass tube 2. Present on the inside of glass tube 2 is a film of a fluorescent material, which is capable of converting UV light into UV-A light, UV-B light or visible light.

Glass tube 2 comprises an inwardly extending cylindrical support 4 at its end, on which a stem 5 (also called “pinch”) is mounted after pole wires 9 and support 4 have been melted therein. An outwardly extending, tubular exhaust tube 6 is mounted on stem 5, which tube is in open communication with the contents of tube 2 via a hole 7 in stem 5. Before final assembly of the lamp 1 takes place, a vacuum is generated in tube 2 by the exhaust tube 6, which will have an even greater length than illustrated in that condition, and tube 2 is filled with the desired (inert) gas mixture. Furthermore, an amount of mercury is introduced into the lamp by using pure mercury or an amalgam, to regulate the mercury vapor pressure in the discharge vessel (burner). Following that, the exhaust tube 6 is heated, causing the glass to soften, squeezed shut and sealed off, so that tube 2 is sealed airtight.

Lamp I furthermore comprises an electrode 8 on either side, which electrode comprises two pole wires 9 and a tungsten spiral wire 10. Spiral wire 10 is coated with a film of an emitter material (containing, among other substances, barium, strontium, calcium and various oxides), which functions to stimulate the emission of electrons. The pole wires 9 are held in position by the stem 5, in which the wires are melted near the sides thereof, which wires are furthermore connected to plug pins 11. Plug pins 11 are held in position in an electrically insulating disc 12, which forms part of a metal end cap 13. End cap 13 is fixed to the glass tube by means of an annular film of glue 14.

Plug pins 11 can be inserted into a lamp fitting, which supplies lamp 1 with current. The resulting discharge between electrodes 8 causes the mercury vapor molecules to emit UV light, which is converted into light having the desired wavelength(s) by the fluorescent film on the inside wall of tube 2.

FIG. 2 is a perspective view of a detail of the fluorescent lamp 1 of FIG. 1, wherein like parts are indicated by the same numerals. At the end of the exhaust tube 6 facing away from the tube 2 an auxiliary electrode 15 is fitted in such a way that the exhaust tube 6 functions as a discharge path between the electrode 8 acting as a main electrode. The main electrode 8 on either side of the tube 2 is connected to an alternating (main) current supply 16. However, independent therefrom, the auxiliary electrode 15 is fed by a DC current unit 17. That unit not only powers up the auxiliary discharge between the main electrode 8 and the auxiliary electrode 15, but also regulates the average DC current with the help of a thermo-couple 18 or detected light change, color shift or burner voltage. The thermo-couple 18 for example, measures the temperature at a so-called “cold spot” on the cathode-side behind the auxiliary electrode 15 in the sense that when that temperature goes up the average DC current increases and in case that temperature goes down the average DC current decreases. Accordingly, the thermo-couple ensures that the average DC current is regulated in such a way that the mercury density in the tube 2 is always fixed (independent of the ambient temperature or the temperature of the wall of the lamp) and that the light output is always maximal, under the given burner conditions.

According to FIG. 3 the auxiliary electrode 15 is connected to a passive transformer circuit 19 comprising a coil 21 which is electro-magnetically coupled to coils 22 which are connected to the pole wires 9 of the main electrode 8. A diode 20 is connected between the auxiliary electrode 15 and the coil 21 for generating a DC current through the auxiliary electrode 15.

It will be apparent that within the scope of the invention many variations are possible for a person skilled in the art.

The scope of the invention is not limited to the exemplary embodiments described herein. The invention is embodied in every navel feature and every combination of features. The numerals that are mentioned in the claims do not limit the scope thereof. The use of the word “comprise” does not exclude the presence of elements other than those mentioned in the claims. The use of the word “a” or “an” before an element does not exclude the presence of a multitude of such elements.

1. Fluorescent lamp comprising a glass discharge vessel in which an ionizable and vaporizable filling is present, which discharge vessel is on two sides provided with a tubular end portion including a glass stem, wherein an exhaust tube extends axially outwardly from said stem for supplying and/or discharging gases during production of the lamp, wherein a main electrode extends axially inwardly through the stem for generating and maintaining a discharge in the discharge vessel, and wherein the lamp comprises means including an auxiliary electrode for controlling the pressure of said filling in the vapor phase, despite changes in temperature thereof, characterized in that said auxiliary electrode is located on at least one end portion for generating and maintaining an auxiliary discharge between the main electrode and the auxiliary electrode.

2. Fluorescent lamp according to claim 1, wherein the auxiliary electrode is located near an end of the exhaust tube facing away from the discharge vessel for generating and maintaining the auxiliary discharge through the exhaust tube acting as a discharge path between the main electrode and the auxiliary electrode.

3. Fluorescent lamp according to claim 1, wherein the auxiliary electrode is fed by a DC current.

4. Fluorescent lamp according to claim 3, wherein the DC current can be varied in order to regulate the pressure of said filling in the vapor phase.

5. Fluorescent lamp according to claim 4, wherein the DC current can be varied dependent on an temperature on the cathode-side of the auxiliary electrode as measured by means of a thermocouple, detected change in light output, color change or burner voltage.

6. Fluorescent lamp according to claim 1, wherein the auxiliary electrode is connected to a passive transformer circuit comprising a coil which is electro-magnetically coupled to coils which are connected to the pole wires of the main electrode.

7. Fluorescent lamp according any of the previous claims 1, wherein the electrodes are connected to a dimming circuit.

8. Method for manufacturing a fluorescent lamp, wherein a glass discharge vessel is on two sides provided with a tubular end portion including a glass stem, wherein a main electrode is fitted to extend axially inwardly through the stem for generating and maintaining a discharge in the discharge vessel, wherein an exhaust tube is fitted to extend axially outwardly from said stem, through which exhaust tube the discharge vessel is filled with an ionizable and vaporizable filling, and wherein the lamp is provided with means including an auxiliary electrode for controlling the pressure of said filling in the vapor phase, despite changes in temperature thereof, characterized in that said auxiliary electrode is fitted on at least one end portion for generating and maintaining an auxiliary discharge between the main electrode and the auxiliary electrode.
